(19) United States
(12) Patent Application Publication
(10) Pub. No.: US 2005/0181772 A1
(43) Pub. Date: Aug. 18, 2005

(54) Wireless network alarm service

(76) Inventor: William A. Crowell, Richmond, VA (US)

Correspondence Address: J. Michael Martinez de Andino, Esq.;HUNTON & WILLIAMS, Riverfront Plaza, East Tower, 951 E. Byrd St., Richmond, VA, 23219-4074, US

(21) Appl. No.: 10/780,959

(22) Filed: Feb. 18, 2004

(51) Int. Cl. H04M 11/04

(52) U.S. Cl. 455/414.1; 455/404.1

(57) ABSTRACT

A wireless network alarm service is disclosed. The alarm service includes a network service center in communication with a plurality of wireless phone devices. The service includes receiving a request at the network service center from a wireless phone user to schedule an alarm call. The request is typically made via a wireless phone in which a voice recognition system receives verbal requests from the wireless phone user to schedule the alarm call. The service establishes alarm call parameters based on information received from the wireless phone user and/or the wireless phone, saves it to a database, and then initiates the alarm call when the time and date for the alarm call arrives. The service is capable of sending many independently scheduled alarm calls simultaneously to many different wireless phones.

### BACKGROUND OF THE INVENTION

Wireless phones have become increasingly pervasive in today's society. As wireless phone service coverage improves across the U.S. and elsewhere around the world, a person with a wireless phone is almost never out of contact from someone who is trying to reach them. Wireless phones are just one adaptation to society's increased mobility and are often used by businesspersons and others who travel frequently. However, increased mobility often comes with the challenge of negotiating more complex schedules made possible by that mobility.

One of the advantages of a wireless phone is that it permits individuals to balance complex schedules by giving them an ability to be in almost continuous communication with others. But in many circumstances, the most difficult portion of a complex schedule may often be actually remembering when different events begin or end, and not the complexity of the events themselves.

### SUMMARY OF THE INVENTION

Accordingly, it may be desirable to have a method for implementing an alarm service over a wireless network that a wireless phone user can use to quickly and easily schedule an alarm call to be sent to the user at one or more locations, including the wireless phone. A method for providing a wireless network alarm service is provided. The method comprises receiving a request at a network service center to schedule an alarm call to be delivered to a wireless phone, establishing alarm call parameters based on information received from at least one of the wireless phone and a wireless phone user, saving the alarm call parameters on a database at the network service center; and initiating the alarm call to the wireless phone at a time and date corresponding to the alarm call parameters.

A system for providing a wireless network alarm service is also provided. The system comprises a network service center in communication with a plurality of wireless phones to deliver a plurality of alarm calls to the wireless phones at a scheduled date and time, wherein the network service center comprises a user interface having a voice recognition system capable of translating verbal communication into data readable by a computer to establish alarm call parameters, at least one database containing stored alarm call parameters, wherein the alarm call parameters include at least a date parameter, a time parameter, and a destination parameter, a call generator for placing a plurality of alarm calls simultaneously to a plurality of different wireless phones when a clock associated with the network service center matches the alarm call parameters stored within the database, and a processor to execute and manage interactions between the user interface, at least one database, and call generator.

### BRIEF DESCRIPTION OF THE DRAWINGS

Exemplary embodiments of the invention are now described in more detail with reference to the following drawings.

FIG. 1 illustrates a method for implementing a wireless network alarm service according to one exemplary embodiment of the invention.

FIG. 2 illustrates a method for implementing one aspect of a wireless network alarm service according to another exemplary embodiment of the invention.

FIG. 3 illustrates a method for implementing another aspect of a wireless network alarm service according to another exemplary embodiment of the invention.

FIG. 4 illustrates a method for implementing yet another aspect of a wireless network alarm service according to an exemplary embodiment of the invention.

FIG. 5 illustrates a system for implementing a wireless network alarm service according to one exemplary embodiment of the invention.

FIG. 6 illustrates a system for implementing a wireless network alarm service according to an exemplary embodiment of the invention comprising a plurality of call generators.

### DETAILED DESCRIPTION OF EXEMPLARY EMBODIMENTS

Exemplary embodiments of the invention provide a wireless network alarm service. The alarm service provides a way in which individuals can be reminded of an important event or receive a wake-up alert regardless of the individuals' location by sending an alarm call to the individuals' wireless phones over a wireless phone network. The alarm service uses voice interaction between a wireless phone user and a user interface at a network service center that has voice recognition capabilities to obtain parameters to schedule the alarm call. Certain parameters needed for the alarm call may be automatically determined by the network service center.

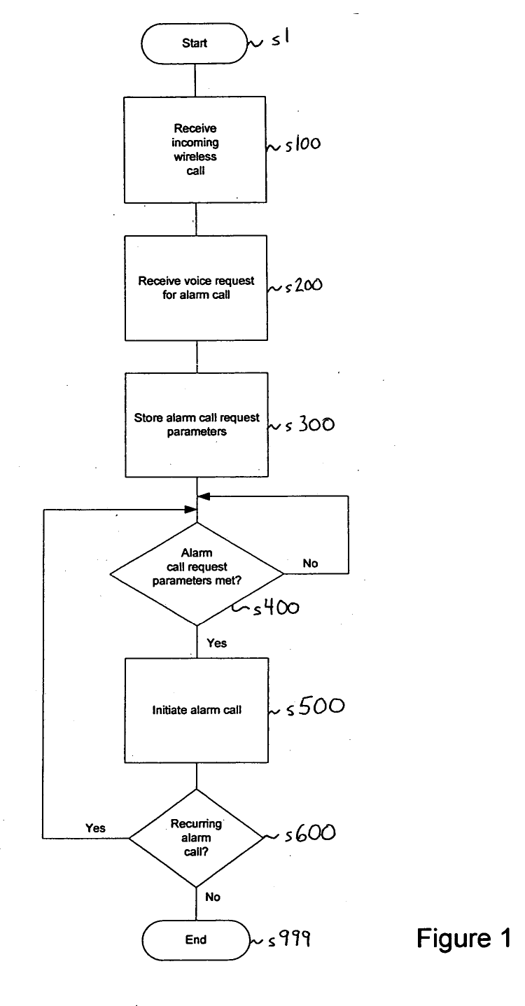

An exemplary embodiment for providing the service is shown in more detail with respect to FIG. 1 which begins at step s1.

At step s100, an incoming wireless call is received by a network service center. The wireless call may be placed by a wireless phone user dialing a toll free number, for example. The wireless call is then routed over a conventional wireless telephone network and connects the wireless user to the network service center. The wireless network alarm service may advantageously be provided as a service of the user's own wireless carrier. Alternatively, it may be provided by an independent entity unconnected with the user's wireless carrier. In exemplary embodiments in which the service is provided by the user's wireless carrier, the user may be able to access the wireless network alarm service by dialing the wireless carrier's customer service number. Preferably, this may be accomplished using a speed dial function associated with the user's wireless phone, such as a special shortcut number provided by the wireless carrier, for example.

Once the incoming wireless call is received in step s100 and the wireless user is in communication with the network service center, the network service center receives a request from the user to schedule an alarm call through a user interface as shown in step s200. The user interface is equipped with a voice recognition system to receive verbal commands from the wireless user. In this manner, the wireless user may quickly and easily request an alarm call without the need to enter digits or progress through a series of menus. The user's request may be as simple as saying “February 8, 10 a.m.” after the call has been received by the network service center. Any voice recognition system may be used that is capable of recognizing a human voice and translating that voice into a digital data format that can be stored or processed by a computer.

After the request to schedule the alarm call has been received, the network service center stores parameters of the alarm call request in a database, as shown in step s300. The alarm call parameters stored by the network service center may vary, but at least include the day and time the alarm call is to be initiated and the telephone number or numbers to which the alarm call is to be delivered. The network service center keeps track of the current date and time, preferably using an atomic clock. The network service center continuously or intermittently checks the current date and time against alarm call parameters stored in the database, as shown in step s400. When the current date and time match the parameters stored in the database for a particular wireless user, the network service center initiates an alarm call to the wireless user in step s500.

In certain cases, a user may have a standard appointment or desire a wake-up alarm call at a regular interval, such as every Monday for example. To avoid the user having to call and request each alarm call separately, a request for a recurring alarm call may be received and stored by the network service center. If information stored by the network service center indicates that the alarm call is a recurring alarm call as shown in s600, following the alarm call initiation in step s500, the method may return to step s400 to compare the current time against the next time the recurring event is scheduled. When the alarm call parameters again match the current time and date, another alarm call is delivered to the wireless user. If the alarm call is not a recurring alarm call, the process may end at s999 following the network service center's placing the alarm call to the wireless user.

It should be appreciated that thousands of individuals may use the wireless network alarm service to independently schedule an alarm call and that many persons may all desire an alarm call at the same time, particularly in the case of a wake-up call. Thus, the network service center is equipped to place many calls to many telephone numbers at the same time. This may be accomplished by using one or more call generation systems, each of which is capable of placing a certain number of simultaneous calls. Any system capable of placing multiple simultaneous telephone calls may be used.

If the number of scheduled alarm calls exceed the call generation systems' capacity to make calls simultaneously, the alarm calls may be queued based on a priority system determined by the network service center. For example, the wireless network alarm service may be provided as a subscription service with multiple subscriber levels. One user may subscribe to a premium version of the wireless network alarm service that guarantees an exact alarm call at the requested date and time regardless of call traffic, while another user may subscribe to a standard or an economy service that provides an alarm call within various windows of the requested alarm call time. The time windows may be associated with escalating levels of service rates or plans, such as one rate for a two minute time window and another for a five minute time window by way of example only. Example alternative arrangements may provide a first in time queuing system, based on how far in advance a user scheduled the alarm call, with the earliest scheduled alarm call initiated by the call generation system first, and so on.

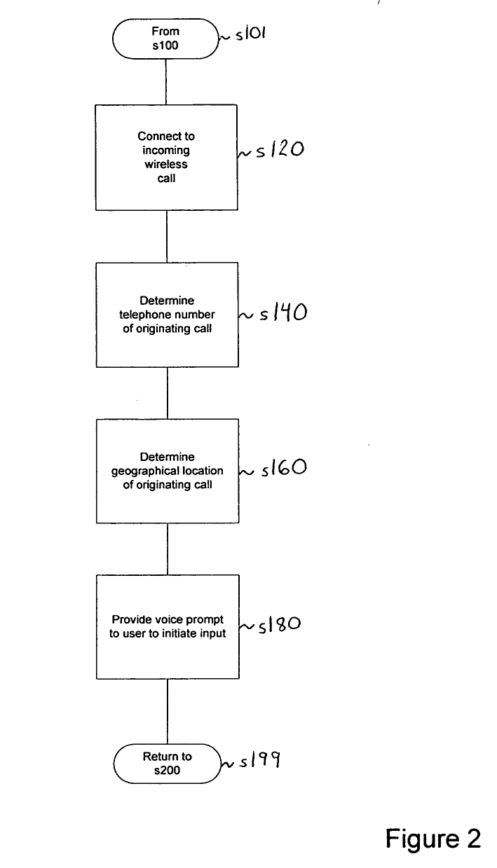

FIG. 2 shows an exemplary embodiment of the invention that shows step s100 of FIG. 1, “Receive incoming wireless call” in more detail. In step s120, the wireless telephone call is connected with the network service center. Once the call is answered and the wireless user and the network service center are connected, the network service center determines the telephone number of the originating call from the wireless phone in step s140. This may be accomplished by using ANI or other intelligent network techniques that perform a “caller-id” function. Alternatively, the network service center could also determine the telephone number by simply asking the caller to identify what number the call is coming from.

The geographical location of the incoming call is also determined, as shown in step s160. This information may advantageously be determined by identifying the location of the tower from which the wireless call was initially routed when the call was originated. By tracing the incoming call from the network service center back across the towers from which the call traveled, and ultimately to the tower from which the call was initially routed, the network service center can determine the general area at which the wireless user is located.

The telephone number and geographical location of the wireless phone may be used by the network service center to set certain default parameters of the alarm call, such as the telephone number to which the alarm call is to be delivered or the time zone for the alarm call. This avoids the wireless phone user from needing to specifically identify these items when scheduling an alarm call, further increasing the simplicity and speed with which one can easily and quickly schedule an alarm call.

The network service center may also provide an audible prompt to the wireless phone user in step s180 to advise the user that the call has been answered and that the user may begin to provide input. For example, the network service center may thank the user for dialing the alarm service. This may provide the wireless phone user with some indication of who was called, in case the alarm service was dialed in error. The prompt may also include a request from the network service center to the wireless phone user to provide information about the alarm call. The prompt might include a phrase such as “Please tell me when you would like your alarm call” or some similar audible statement that would prompt the wireless user to engage in a verbal dialogue with the network service center, so that the network service center can receive sufficient information to store an alarm call request. It should be appreciated that although steps s120-s180 are shown in descending order, once the call is connected in step s120 the other steps may occur in any order or even simultaneously.

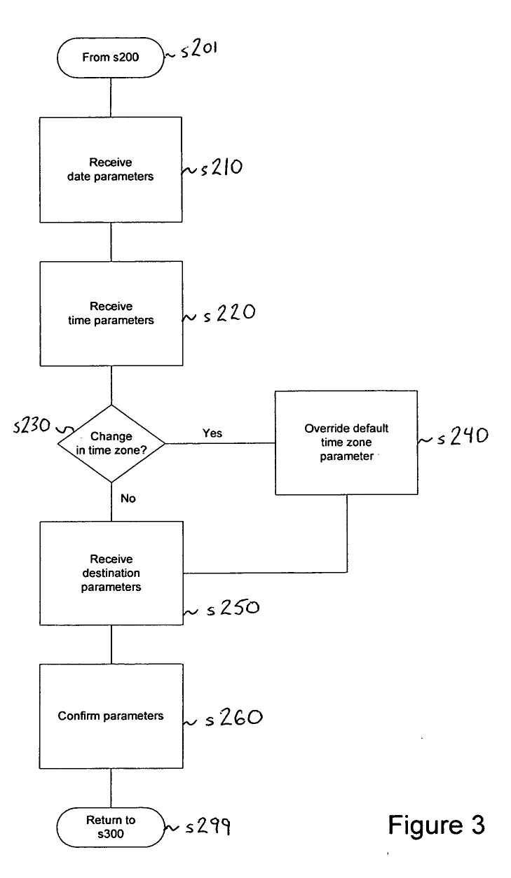

After the network service center has received the incoming wireless call, the method passes to step s200 and the network service center is ready to receive the alarm call request. The verbal request by a user to schedule an alarm call is discussed in more detail with respect to FIG. 3. Using the voice recognition system of the user interface, the network service center is configured to receive verbal information from the wireless phone user for use as alarm call parameters to schedule the alarm call. One such piece of information received from the wireless user is a date parameter, as shown in step s210.

The network service center is equipped to accept information pertaining to a specific calendar date, such as “February 21,” for example. The voice recognition system may also be programmed to recognize other temporal terms that may be used interchangeably with specific dates. For example, the voice recognition system may be programmed to accept terms such as “today” or “tomorrow” or “next Tuesday” for example, and associate them with a specific calendar date, based on the service center's knowledge of the current date. The date parameter also permits the wireless user to schedule a recurring alarm call such as “Weekdays” or “Weekends,” or “Thursdays” for example.

Another example of a recurring alarm call could be for “Holidays” which would schedule an alarm call for dates corresponding to Federal holidays. Again, based on calendar information accessible to the network service center, logic of the voice recognition system may be used to associate the received term with specific calendar dates. In any situation in which the voice recognition system is unable to discern the user's verbal request, the user may be prompted to repeat the information.

The wireless phone user also provides a time parameter, as in step s220, that corresponds to the time the user desires to receive the alarm call. The voice recognition system of the network service center may be programmed to understand times using either a 12 hour (a.m./p.m.) scale or a 24 hour scale. Likewise, the system may be programmed to understand other temporal terms such as “noon” or “midnight,” and associate them with an appropriate numerical time.

As discussed previously with respect to FIG. 2, the network service center may establish a default time zone parameter for the alarm call based on the geographical location from which the wireless call was received. Thus, the user may simply state a time parameter of “8 a.m.” while calling the network service center from Boston, for example. The alarm call request will be understood to have a time parameter of 8 a.m. and a time zone parameter of Eastern Standard Time, based on the determination that the wireless user requested the alarm call while in that time zone. In some cases, the user may state a specific time zone. The network service center receives this time zone information through the user interface like other verbal information received from the wireless user. It then compares the received time zone information against the default time zone parameter, as shown in step s240. If the two are the same, no change is needed. If the time zone stated by the wireless user is different, step s250 demonstrates that the time zone verbally received from the wireless phone user replaces the default time zone as the time zone parameter for the alarm call.

The ability of the wireless phone user to select a time zone and override the default time zone may be particularly advantageous for travelers who call the network service center to schedule an alarm call while in one time zone, but anticipate being in a different time zone when the alarm call is to be initiated. For example, a businessman may want to schedule an alarm call before departing Los Angeles to wake him the next day in Boston for an important meeting that he will be attending. In order to ensure that the alarm call occurs at 6 a.m. Eastern, not at 6 a.m. Pacific, the user may state the time zone that should apply to the alarm call when scheduling the alarm call.

In certain cases, the user may have scheduled a recurring alarm call, but wants to adjust the time zone for a particular date. For example, a wireless user in Virginia may have a recurring weekday alarm call at 7 a.m., but plans to be in Iowa on one day during that week. To change the time zone parameter for a particular alarm call which is part of a recurring alarm call, the wireless user may contact the network service center and cancel the recurring alarm call, make a new alarm call for the desired adjustment, and finally schedule a new recurring alarm call that is the same as the original alarm schedule after the wireless user has returned to a new location.

Alternatively, the wireless user may contact the network service center and simply override the time zone parameter for that particular alarm call, without the need to cancel a recurring alarm call and later reschedule it again. In this case, the requested override shifts the time zone parameter for a particular alarm call, but the time zone parameter then reverts back to that of the originally scheduled recurring alarm call. In the above example, the default time zone parameter will have been established as Eastern Standard Time, for the recurring alarm call in Virginia. If the wireless user calls the network service center and says for example, “Tomorrow, 7 am Central,” the network service center will recognize that all parameters of the recurring alarm call are the same except for the time zone, assuming that “tomorrow” is a “weekday” that corresponds to the originally scheduled recurring alarm call. In this way, the network service center recognizes that both the day and time have not changed, only the time zone. Thus, the network service center is programmed to override the default time zone consistent with the particular instruction given, but revert to the normal time zone thereafter.

Although the time zone determination has previously been described as static, based on the time zone determined at the time the alarm call is scheduled, it should be appreciated that in certain embodiments, the network service center may determine the time zone parameter dynamically. For example, technology may be available in some instances to determine where the wireless phone is at all times, even immediately before the alarm call is made. Based on the geographical location of the wireless phone at the time the alarm call is to be delivered, the network service center may be programmed to dynamically adjust the time zone for which the alarm call is to be delivered. For example, if a wireless user has an alarm call scheduled for 7 a.m. and the network service center determines that the user is in California, the alarm call will be delivered at 7 a.m. Pacific Standard Time.

The network service center may receive the wireless user's input all at once, or it may provide a separate prompt to the wireless user for each piece of information, such as first prompting the wireless user to identify what day, followed by prompting the wireless user to identify what time for which the alarm call should be made. It should be appreciated that the alarm call parameters may be received from the wireless user in any order, and that the voice recognition system is capable of discerning between a time and date so that “Friday, 10 a.m.” is recognized as the equivalent of a user who says “10 a.m. Friday.”

Additionally, the network service center may receive, with or without prompting, destination parameters for the alarm call, as shown in step s250. The destination parameter includes the telephone number(s) to which the alarm call is to be directed. The default number to which the alarm call is sent is the wireless telephone number from which the alarm call was requested and which is preferably determined automatically based on information received from the wireless phone, as described earlier. However, the wireless user may identify additional destination parameters such as identifying a particular telephone number to which the alarm call should be sent in addition to, or instead of, the user's wireless phone. The user may verbally identify the telephone number to which the alarm call should be placed. Preferably, the additional numbers may be selected from a pre-established directory that is personal to each wireless user and is stored on a database at the network service center. A wireless user's directory may be established to identify a particular telephone number with a specific word. For example, the wireless phone user may identify that the alarm call is to be delivered to “Work,” which term may be associated in that user's directory with the wireless user's office phone number that the wireless user previously provided when establishing the directory.

Identifying additional phone numbers as destination parameters in requesting an alarm call may be particularly advantageous when a wireless user has multiple wireless phones, such as a work and a personal wireless phone. This permits the alarm call to be delivered to the user even if the user forgets which wireless phone was used to request the alarm call. It may also be advantageous to permit a wireless user to request an alarm call for multiple people, such as for the wireless user and several friends to wake-up early for a fishing expedition, for example.

After the various alarm call parameters are received, the network service center may optionally return an audible confirmation to the wireless user of the alarm call parameters that will be used to generate the alarm call, shown in step s260. A confirmation may be advantageous to the wireless user to ensure that the correct alarm call was requested, especially when the user is traveling and, when scheduling the alarm call, may forget about time zone changes or what date a certain day falls on, for example. If the wireless user recognizes the returned alarm call parameters as incorrect, the wireless user may correct them by stating the proper parameters to schedule the desired alarm call. If the alarm call parameters are correct, the method returns to step s300 in which the alarm call parameters are stored in a database.

In the database, the stored alarm call parameters for each wireless user are compared against current information. The comparison may take place continuously, or intermittently, such as once every minute, until the date and time for the alarm call matches the current date and time.

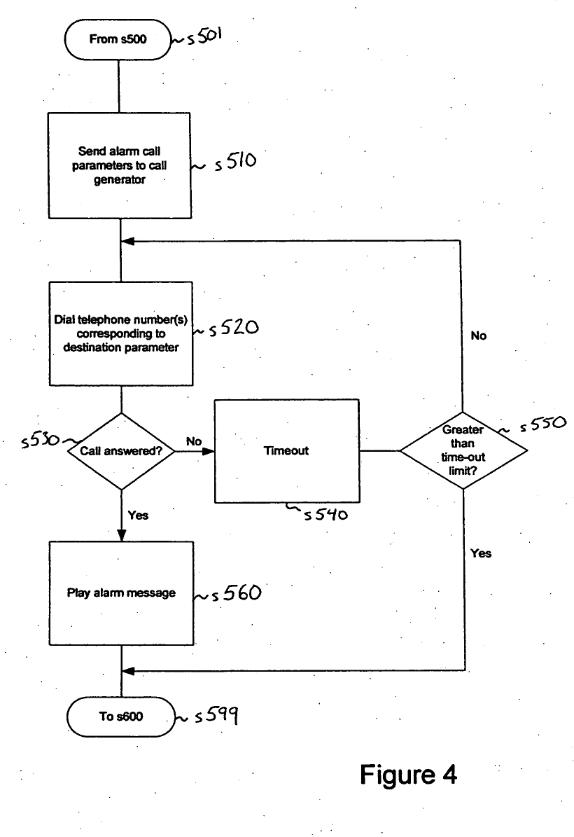

Once the time for the alarm call arrives, the alarm call is initiated, as shown in more detail in FIG. 4, which begins with alarm call parameters being passed to the call generator in step s510. The network service center, using one or more call generation systems, dials the telephone number(s) corresponding to the destination parameter for the scheduled alarm call in step s520. The network service center waits to see whether the call is answered at step s530. If the call is not answered within a predetermined period, such as 30 seconds or 7 rings by way of example only, the network service center causes the call attempt to time out in step s540. After a time out, the network service center analyzes whether it has caused the alarm call to be timed out more than a predetermined number of times in step s550. If not, the method may return to step s520. Upon returning to step s520, the wireless phone number or other phone number established by the destination parameter may be immediately dialed again. Alternatively, the wireless user's alarm call delivery may be routed to the end of a queue. After any remaining alarm calls for the same date and time are delivered, then the telephone number corresponding to the undelivered alarm call is dialed again. In the event that the network service center determines that the alarm call has timed out more than the permitted number of times, the network service center may purge that alarm call request from the system.

After someone answers the telephone to which the alarm call is directed, the network service center may be directed to hang up the call. The network service center may optionally be programmed to first deliver an audible message to the wireless user that the call is the requested alarm call. In the event that the wireless user has a voicemail system that answers the alarm call and an audible message is to be delivered, the message may be delivered to the voicemail system, as a confirmation that the alarm call was in fact delivered by the network service center.

The network service center may be programmed to allow the user to optionally state a reason for the alarm call, creating a purpose parameter, an alarm call parameter that may be delivered as part of the audible message when the alarm call is made.

The purpose parameter may be used to personalize the alarm call, such as telling the user that the call is the requested wake-up call, or that it is time to pick up the wireless user's children, or some other parameter identified by the user when scheduling the alarm call. In some embodiments of the invention, the audible message indicating the call is an alarm call could be made by programming the wireless phone to ring with a different ring tone for the alarm call than would normally occur were the call a regular telephone call.

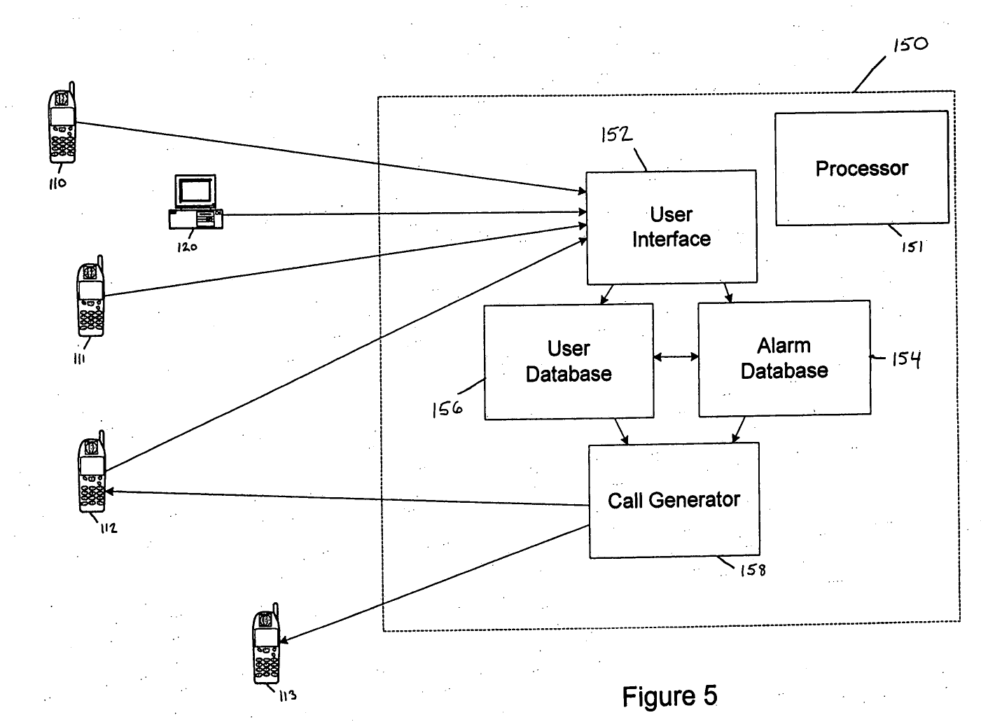

An exemplary embodiment of a system to implement the wireless network alarm service is shown in FIG. 5. The system 100 includes a network service center 150, which is preferably an integrated digital system including a processor 151 to execute and manage interactions between various components of the network service center 150. The network service center 150 is configured to receive incoming wireless calls over a conventional wireless telephone network from a plurality of wireless telephones 110-113. It may also be desirable to configure the network service center 150 to allow a wireless phone user to access the network service center 150 via the Internet, such as by using a computer 120.

By using the Internet, a wireless phone user may conveniently access certain aspects of the network service center through a graphical user interface without using the wireless phone. The wireless user may use the computer 120 to perform functions such as identifying alarm call parameters over a secure web site to schedule an alarm call that is stored on a database and later directed to the user's wireless phone at the appropriate time. The wireless user may also conveniently use the computer 120 to modify other aspects of the wireless network alarm service, such as create or edit a personal phone directory, update address information, and the like.

In any case, the user requesting the alarm call interacts with a user interface 152 of the network service center 150. The user interface 152 includes a voice recognition system to receive verbal alarm call requests from the wireless telephone users and translate those requests into data that can be stored and accessed in digital form. The user interface 152 may also be adapted to act as a graphical interface, such as for wireless users that access the network service center 150 via a computer 120.

Information received from the wireless user and/or the wireless phone through the user interface is stored on one or more databases. A preferred embodiment includes two databases associated with the network service center 150. One database is a user database 156. This database may contain information such as names of wireless users that subscribe to the wireless network alarm service and may further be associated with particular wireless numbers so that when an incoming phone number is recognized, so also is the user's name and/or other data stored in the user's record within the database. The user database 156 may also include a personal phone directory for each wireless user that includes various telephone numbers associated with a term assigned by the wireless user for use in voice-activated dialing.

A second database, an alarm database 154, stores a record of alarm call parameters such as dates and times for each scheduled alarm call, as well as the destination parameter. The alarm database 154 may then compare the current date and time against all of the scheduled alarm calls stored in the alarm database 154. When the time for a particular alarm call arrives, the alarm database 154 passes the destination parameter to the call generator 158 to initiate the alarm call, along with any other information stored in the alarm database 154 to be delivered to the wireless user for a particular alarm call, such as the purpose parameter.

Alternatively, the alarm database 154 could be configured to store only certain alarm call parameters. Thus, when the alarm call is ready to be delivered, the alarm database 154 communicates with the user database 156 and indicates that an alarm call is about to be dispatched to the call generator 158 for delivery. This information may be used by the user database 156 to in turn pass additional information stored in the user database 156 to the call generator 158.

Preferably, though, all alarm call parameters are stored in the alarm database 154 for efficiency and to reduce processing time caused by additional interaction between the user database 156 and alarm database 154, which may delay prompt alarm call delivery.

The alarm database 154 may purge the alarm call record and all associated alarm call parameters from its memory after the information is passed to the call generator 158. In the case of recurring alarm calls, the recurring alarm calls may each be recognized and stored as independent events, in which case each alarm call record is preferably purged after it is passed to the call generator. The recurring alarm call may also be saved as one repeating event, so that the alarm call record is not purged from the alarm database 154 until the wireless user so instructs by contacting the network service center through the user interface.

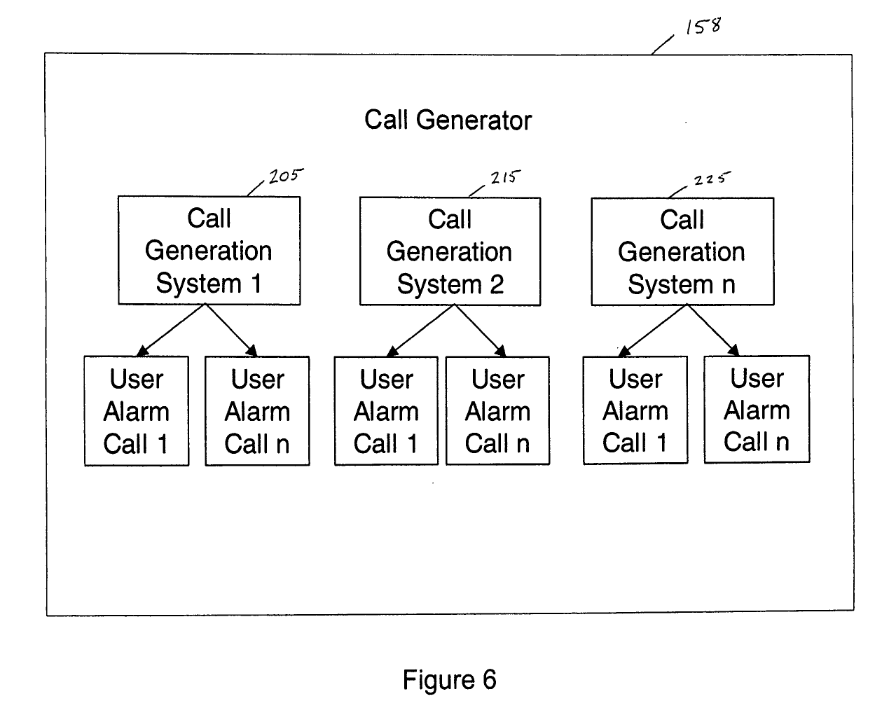

The call generator 158 may comprise one or more call generation systems as shown in FIG. 6. Each call generation system is responsible for initiating n calls simultaneously. In the event that the number of alarm calls required to be sent at one time is greater than its capacity or other number of calls that a particular call generation system 205 is programmed to accept (i.e. n+1), an additional call generation system 215 may be used. If multiple call generation systems 205, 215, 225 are used, it may be desirable to distribute the call load evenly across all of the call generation systems 205, 215, 225. If all of the call generation systems 205, 215, 225 are full, the network service center 150 may rely on a queuing system with a priority assigned to each wireless user, stored in the user database 156, and passed to the call generator 158 to establish a delivery order for the various simultaneously scheduled alarm calls.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breadth and spirit of the present invention as disclosed herein.

1. A method of providing an alarm service over a wireless phone network comprising:
receiving a request at a network service center to schedule an alarm call to be delivered to a wireless phone;
establishing alarm call parameters based on information received from at least one of the wireless phone and a wireless phone user;
saving the alarm call parameters on a database at the network service center; and
initiating the alarm call to the wireless phone at a time and date corresponding to the alarm call parameters.

2. The method of claim 1 wherein the request to schedule the alarm call is received from the wireless phone user via an incoming telephone call from the wireless phone to which the alarm call is to be delivered.

3. The method of claim 2 wherein the request to schedule the alarm call is a verbal request received from the wireless phone user and the method further comprises translating the verbal request into data by a voice recognition system at the network service center.

4. The method of claim 3 further comprising transmitting an audible prompt to the wireless phone user prior to receiving the verbal request from the wireless phone user to schedule the alarm call.

5. The method of claim 2 further comprising determining a geographical location of the wireless phone when the alarm call is scheduled to establish a default time zone for the alarm call to be initiated.

6. The method of claim 5 further comprising changing the default time zone.

7. The method of claim 2 further comprising determining the telephone number of the wireless phone from which the request is received.

8. The method of claim 1 further comprising playing a recording when a wireless phone user answers the alarm call, wherein the recording identifies the alarm call to the wireless phone user.

9. The method of claim 2 further comprising receiving a request from the wireless phone user to schedule an alarm call to be delivered to a telephone in addition to the wireless phone from which the alarm call request was placed.

10. The method of claim 9 wherein the telephone number of the telephone in addition to the wireless phone from which the alarm call request was placed is obtained from a pre-established directory associated with the wireless phone user.

11. The method of claim 1 further comprising simultaneously initiating at least one additional alarm call to a different wireless phone, wherein the at least one additional alarm call was independently scheduled to be delivered at the same time and date.

12. The method of claim 1 wherein the request to schedule an alarm call is for an alarm call to be delivered at a specific time on a specific date.

13. The method of claim 1 wherein the request to schedule an alarm call is for an alarm call to be delivered at a specific time on multiple dates.

14. The method of claim 2 further comprising providing the wireless phone user an audible confirmation of the scheduled alarm call.

15. The method of claim 1 wherein the alarm call parameters comprise a time parameter, a date parameter, a destination parameter, and a time zone parameter.

16. The method of claim 1 wherein the request to schedule the alarm call is received from the wireless user via a network of interconnected computers.

17. A method for providing a wireless network alarm service comprising:
receiving an incoming call from a wireless phone at a network service center;
providing an audible prompt to a wireless phone user to provide input to schedule an alarm call.
receiving a voice request from the wireless phone user to schedule an alarm call to the wireless phone;
determining the telephone number of the wireless phone;
determining a time zone where the wireless phone is located at the time of the incoming call;
establishing alarm call parameters based on information received from at least one of the wireless phone user and the wireless phone;
saving the alarm call on a database at the network service center;
providing the wireless user an audible confirmation of the scheduled alarm call; and
initiating the alarm call to the wireless phone at a date and time corresponding to the alarm call parameters while simultaneously initiating additional alarm calls to other wireless phones wherein the additional alarm calls were independently requested for the same date and time by other wireless phone users.

18. A system for providing a wireless network alarm service comprising:
a network service center in communication with a plurality of wireless phones to deliver a plurality of alarm calls to the wireless phones at a scheduled date and time, wherein the network service center comprises
a user interface having a voice recognition system capable of translating verbal communication into data readable by a computer to establish alarm call parameters,
at least one database containing stored alarm call parameters, wherein the alarm call parameters include at least a date parameter, a time parameter, and a destination parameter,
a call generator for placing a plurality of alarm calls simultaneously to a plurality of different wireless phones when a clock associated with the network service center matches the alarm call parameters stored within the database, and
a processor to execute and manage interactions between the user interface, at least one database, and call generator.

19. The system of claim 18, wherein the at least one database comprises a user database and an alarm database.
